(19) United States
(12) Patent Application Publication
(10) Pub. No.: US 2005/0078970 A1
(43) Pub. Date: Apr. 14, 2005

(54) Image forming apparatus and method

(76) Inventor: Ho-dong Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/935,154

(22) Filed: Sep. 8, 2004

(30) Foreign Application Priority Data
Oct. 8, 2003 (KR) 2003-70038

(51) Int. Cl. G03G 15/00

(52) U.S. Cl. 399/21

(57) ABSTRACT

An image forming apparatus and method includes a pickup roller installed to be rotatable in both directions above a cassette onto which sheets of paper are loaded, picking up the sheets of paper one by one, and carrying the sheets of paper into the main body; and a controller determining whether the sheet of paper picked up by the pickup roller is jammed. If a paper jam has occurred, rotating the pickup roller in a reverse direction, thereby returning the jammed paper to the cassette.

### BACKGROUND OF THE INVENTION

This application claims the benefit under 35 U.S.C §119(a) of Korean Patent Application No. 2003-70038, filed on Oct. 8, 2003, in the Korean Intellectual Property Office, the entire disclosure of which is incorporated herein by reference.

### FIELD OF THE INVENTION

The present invention relates to an image forming apparatus and method. More particularly, the present invention relates to an image forming apparatus, which returns a sheet of paper to a cassette from which the sheet of paper came by rotating a pickup roller in a reverse direction when the sheet of paper is jammed and method for accomplishing the same.

### DESCRIPTION OF THE RELATED ART

In general, an image forming apparatus is a device forming a visual image on a sheet of paper according to image signals. During the process of forming an image, a developer receives a digital image signal and attaches toner onto an electrostatic latent image formed on a photosensitive medium, to thereby form a toner image. The toner image is transferred and fused onto a sheet of paper.

Due to humidity and temperature, the sheet of paper used in the image forming apparatus may curl causing a paper jam such that a sheet of paper is caught between devices during conveyance or discharge of the paper. A paper jam impedes the image forming apparatus from performing further operations.

FIG. 1 is a lateral sectional view of a conventional image forming apparatus in which a paper jam has occurred. FIG. 2 is a lateral sectional view illustrating a phenomenon where a sheet of paper is torn in a case where a cassette is pulled out of the image forming apparatus shown in FIG. 1, due to the paper jam.

Referring to FIGS. 1 and 2, the conventional image forming apparatus includes a cassette 10 detachably installed on a main body. A paper plate 11 for holding sheets of paper P is provided in the cassette 10 and is elastically biased upward using a spring 12. Above the cassette 10, a pickup roller 13 is installed for picking up sheets of paper P stacked on the paper plate 11 one on top of the other. The sheet of paper P picked up by the pickup roller 13 is transported into the main body via conveyance rollers 14 and 15 installed along the paper conveyance path.

When the sheet of paper P picked up by the pickup roller 13 is caught between the conveyance rollers 14 and 15 during conveyance, which results in a jammed paper 16, a user typically pulls out the cassette 10 in the direction of the arrow as shown in FIG. 2 in order to remove the jammed paper 16.

In FIG. 2, the sheet of paper is torn when the cassette 10 is pulled out of the main body because part of the jammed paper 16 is caught between the conveyance rollers 14 and 15 and the remainder is pressed onto the paper plate 11 by the pickup roller 13.

If the sheet of jammed paper 16 is torn, it becomes difficult to remove the jammed paper 16. The main body has to be disassembled in the worse case.

### SUMMARY OF THE INVENTION

The present invention provides an image forming apparatus for rotating a pickup roller in the reverse direction when a sheet of paper held by the pickup roller is jammed so that the jammed paper is returned to the cassette, which is then opened to easily remove the jammed paper.

According to an aspect of the present invention, there is provided an image forming apparatus comprising: a pickup roller installed to be rotatable in both directions above a cassette where sheets of paper are stored, picking up the sheets of paper one by one, and carrying them into the main body and the image forming apparatus further comprises a controller for determining whether the sheet of paper picked up by the pickup roller is jammed. If a paper jam has occurred, the pickup roller is rotated in a direction opposite to the direction in which the sheet of paper is picked up, thereby returning the jammed paper to the cassette.

According to another aspect of the present invention, there is provided a method comprising the steps of picking up a sheet of paper one by one using a pickup roller from a cassette on which a sheets of paper are loaded, determining if a paper jam has occurred, and reversing said pickup roller, if a paper jam has occurred. If a paper jam has occurred, the step of rotating the pickup roller in a reverse direction returning the jammed paper is performed. The paper jam is determined by a paper sensor sensing whether said paper has moved completely past the paper sensor within a predetermined amount of time.

### BRIEF DESCRIPTION OF THE DRAWINGS

The above and other features and advantages of the present invention will become more apparent by describing in detail exemplary embodiments thereof with reference to the attached drawings in which:

FIG. 1 is a lateral sectional view of a conventional image forming apparatus where a paper jam has occurred;

FIG. 2 is a lateral sectional view illustrating a phenomenon where a sheet of paper is torn when the sheet of paper is jammed and a cassette is thus pulled out of the conventional image forming apparatus;

FIG. 3 illustrates a schematic configuration of an image forming apparatus according to an embodiment of the present invention;

FIG. 4 is a lateral sectional view illustrating a case where a sheet of paper held by the pickup roller is jammed according to an embodiment of the present invention; and

FIGS. 5 and 6 are lateral section views illustrating an operation where jammed paper is returned to the cassette by rotating the pickup roller reversely according to an embodiment of the present invention.

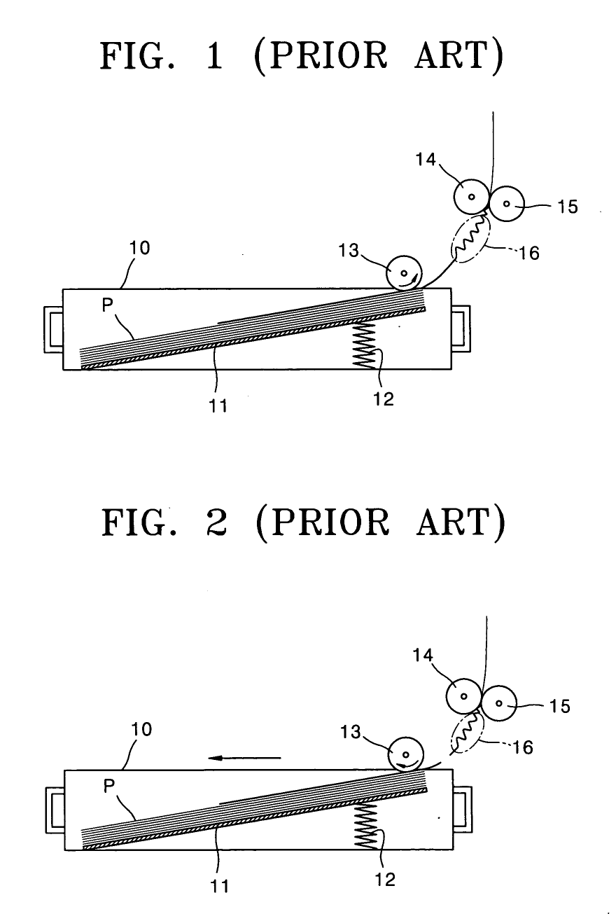

In the figures, like reference numerals apply to like features and structures in each of the figures.

### DETAILED DESCRIPTION OF THE PREFFERED EMBODIMENTS

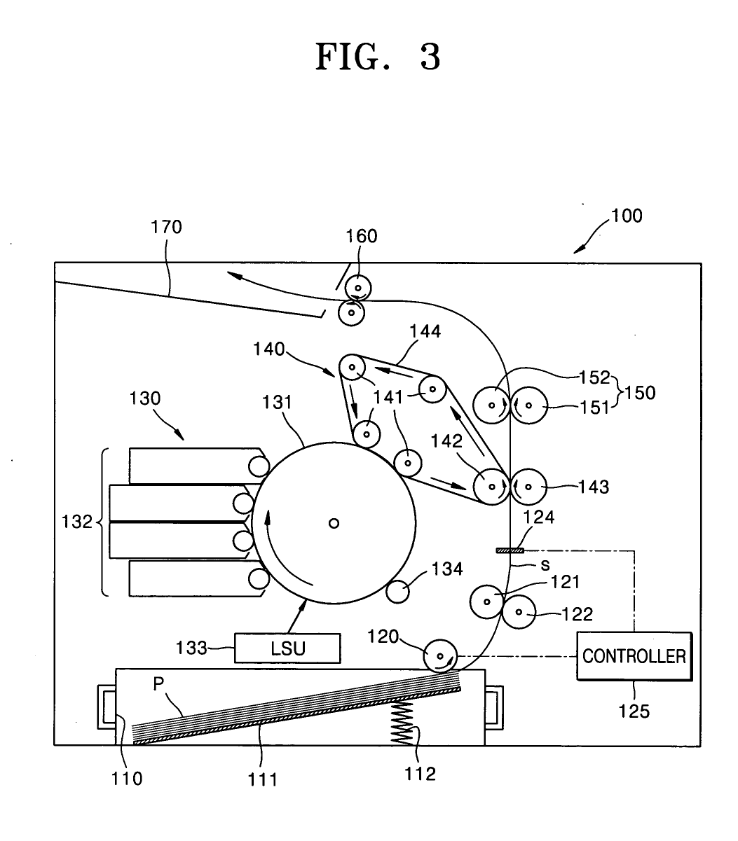

Referring to FIG. 3, an image forming apparatus 100 includes a pickup roller 120, a pair of conveyance rollers 121 and 122, a developer 130, a transferring device 140, a fusing device 150, a discharge roller 160, and a controller 125.

The pickup roller 120 picks up each sheet of paper P loaded on a paper plate 111 provided in a cassette 110 detachably installed in the image forming apparatus 100, and transports the paper into the main body. The pickup roller 120 is installed at an upper portion of the cassette 110 and rotates to convey the sheet of paper P in the direction of the pair of conveyance rollers 121 and 122. The pickup roller 120 can also rotate in the reverse direction.

The paper plate 111 is elastically biased upward, that is, toward the pickup roller 120, by a spring 112 so as to push the sheet of paper P toward the pickup roller 120. This enables the pickup roller 120 to easily pick up the sheet of paper P.

The conveyance rollers 121 and 122 are installed along a conveyance path S to guide the sheet of paper P when the sheet of paper P is moved into the main body by the pickup roller 120.

The developer 130 receives an image signal and forms an electrostatic latent image on a photosensitive medium 131 by means of a laser scanning unit 133. In this state, toner is supplied to the electrostatic latent image from a plurality of toner cartridges 132 installed to come into contact with the photosensitive medium 131, thereby forming a toner image.

The transferring device 140 includes an intermediate transfer belt 144, which is supported by a plurality of support rollers 141 and a transfer backup roller 142. The intermediate transfer belt 144 rotates in a closed loop to transfer the toner image formed on the photosensitive medium 131 onto the sheet of paper P. A transfer roller 143 is installed opposite to the transfer backup roller 142 so that the sheet of paper P will be interposed therebetween. The intermediate transfer belt 144 comes into close contact with the transfer backup roller 142 so that the toner image transferred to the intermediate transfer belt 144 is finally transferred onto the sheet of paper P.

The fusing device 150 includes a plurality of fusing rollers 151 and 152 installed opposite to each other so that the sheet of paper P is interposed therebetween. The fusing rollers 151 and 152 apply heat and pressure to the toner image transferred onto the sheet of paper P to fuse the toner image thereon.

The discharge roller 160 discharges the sheet of paper P passing through the fusing device 150 to a discharge tray 170.

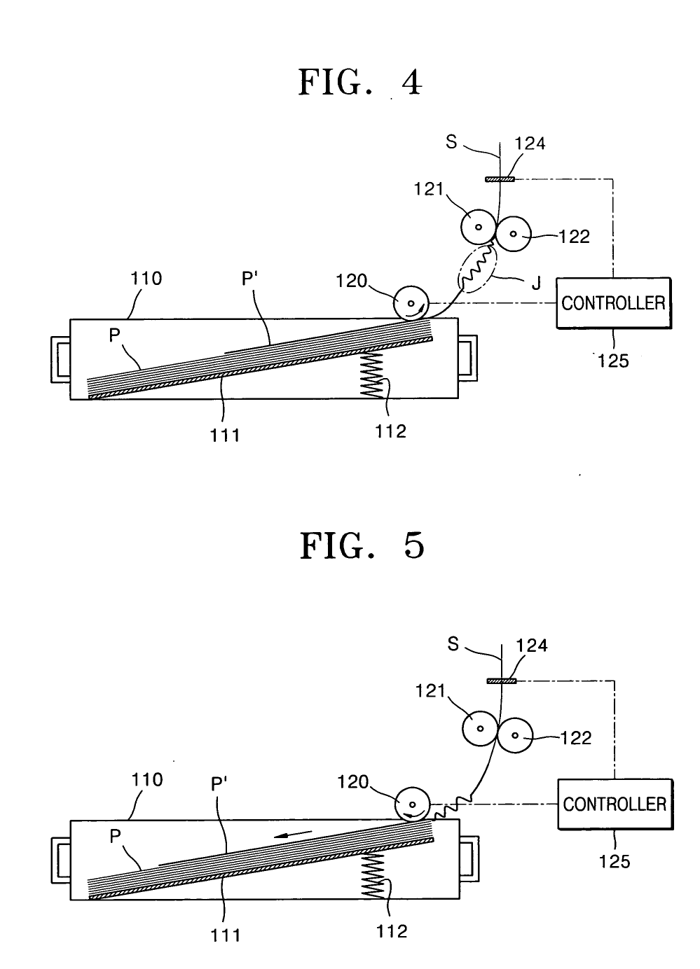

The controller 125 is configured to control the image forming apparatus 100 as a whole. Specifically, the controller 125, coupled to a paper sensor 124 for detecting whether the sheet of paper P is delivered or not, determines whether a paper jam has occurred. If a paper jam has occurred as shown in FIG. 4, the controller 125 rotates the pickup roller 120 in a reverse direction so that the jammed paper P is returned to the cassette 110.

The amount that the pickup roller 120 is rotated in the reverse direction is preferably as much as needed to return the jammed paper P to the cassette 110.

The operation of returning the jammed paper to the cassette is described with reference to the drawings.

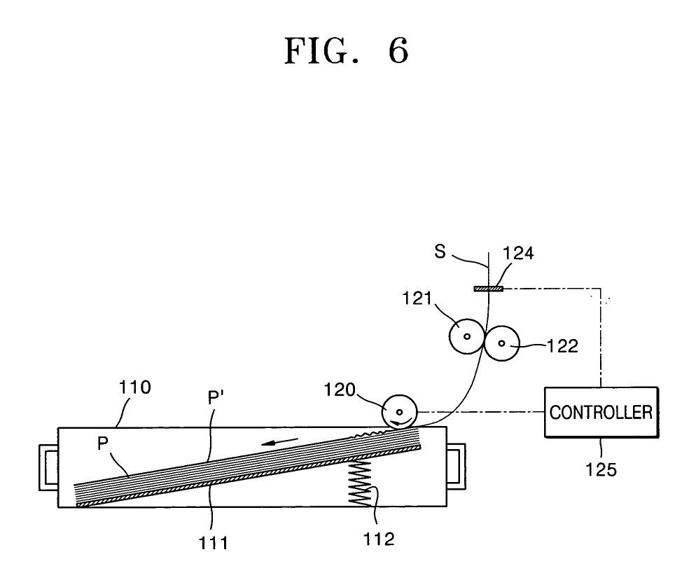

Referring to FIGS. 4, 5 and 6, when the sheet of paper P′ carried by the pickup roller 120 is caught between the conveyance rollers 121 and 122 and does not pass the paper sensor 124 for a predetermined period, the paper sensor 124 recognizes that a paper jam J has occurred.

This information is transmitted to the controller 125, which then rotates the pickup roller 120 in a reverse direction, that is, clockwise in the drawings.

The jammed paper P′ moves from between the conveyance rollers 121 and 122 and returns to the cassette 110.

After the jammed paper P′ is returned and loaded into the cassette 110, a user pulls out the cassette 110 from the main body to remove the previously jammed paper P′.

As described above, an image forming apparatus according to an embodiment of the present invention is advantageous in that, if a paper jam occurs, damage caused by the paper can be alleviated. Also, the jammed paper can be removed by reversing the rotation of the pickup roller, so as to return the jammed paper to the cassette to be removed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image forming apparatus comprising:
a pickup roller installed to be rotatable in both directions above a cassette onto which sheets of paper are loaded, picking up the sheets of paper one by one, and carrying each of the sheets of paper into a main body of said image forming apparatus; and
a controller for determining whether the sheet of paper picked up by the pickup roller is jammed,
wherein if a paper jam occurs, said controller controls the pickuproller to rotate in a direction opposite to the direction in which the sheet of paper is picked up, thereby returning the jammed paper to said cassette.

2. The image forming apparatus of claim 1, wherein the amount the pickup roller is reversely rotated is the amount that it takes to return the jammed paper to the cassette.

3. The image forming apparatus of claim 1, wherein the controller is coupled to a paper sensor located along the conveyance path of paper.

4. The image forming apparatus of claim 3, wherein said controller determines if a paper jam has occurred, if said paper sensor has not sensed said paper within a predetermined amount of time.

5. A method of clearing a jammed paper in an image forming apparatus comprising the steps of:
picking up a sheet of paper using a pickup roller and carrying the sheet of paper into the image forming apparatus;
determining if a paper jam has occurred; and
reversing said pickup roller, if a paper jam has occurred.

6. The method of claim 5, wherein the determining step comprises sensing said paper has arrived at a paper sensing location within a predetermined amount of time.
